(19) United States
(12) Patent Application Publication
(10) Pub. No.: US 2009/0179098 A1
(43) Pub. Date: Jul. 16, 2009

(54) Powder Reclamation Device for Mill Systems

(76) Inventors: Stephen Williams, Hilliard, OH (US); Tod Powers, Dublin, OH (US)

Correspondence Address: BUTZER & CHEN LAW, LLC, 870 HIGH STREET, SUITE 104, WORTHINGTON, OH, 43085, US

(21) Appl. No.: 12/114,759

(22) Filed: May 3, 2008

Related U.S. Application Data
(60) Provisional application No. 61/020,347, filed on Jan. 10, 2008.

(51) Int. Cl. B02C 23/22

(52) U.S. Cl. 241/97

(57) ABSTRACT

A reclamation device for a mill that includes a collector positioned at an output chute of the mill and a connection for airflow from the collector back to the mill. Air and at least some powder that would have been wasted without the reclamation device is collected by the collector and re-fed to the mill through the connection. Preferably, the collector includes a shroud that extends into the collector. Also, a closed loop grinding mill that includes such a reclamation device, and a method of upgrading existing mills to include such a reclamation device.

### BACKGROUND OF THE INVENTION

1. Field of the Invention

This invention relates to a powder reclamation device for mill systems, for example closed loop grinding mill systems of the type used to mill powder from chips or pellets of paint, metal, grain, plastic, or other materials.

2. Description of the Related Art

Mills can be used to grind input material into a powder that has a particular grain size or range of grain sizes. One type of mill is depicted in FIG. 6.

Mill 101 in FIG. 6 is a “closed loop” grinding mill. Blower 102 blows air out vent 103 to create suction that draws air through the mill. Inlet 104 and damper 105 are provided for controlling the amount of suction created by the blower. The mill is “closed” so the suction draws air through the mill. The flow of materials and air (indicated by arrows) through the mill are described below.

Paint, metal, grain, plastic, or other materials to be ground by the mill are fed into hopper 107. The material can be in the form of chips, pellets, or any other suitable input form. The materials pass through rotor 108 in rotor housing 109. Rotor 108 helps to regulate flow of materials into the mill and also inhibits airflow from hopper 107.

Air is drawn into the mill through chiller 110. The chilled air provides cooling for the mill. The air is drawn through 6″×10″ duct 111 to classifier 112. Air is also drawn from duct 111 through 4″ pipe 114, through rotor housing 109 below rotor 108, through 4″ pipe 115, and into classifier 112. This airflow draws materials from rotor housing 109 into the classifier, which grinds the materials.

Air and ground materials are drawn from classifier 112 through 10″ pipe 117 to separator 118, which separates the ground materials from the air. Air is then drawn from the separator through 10″ pipe 120 to filter house 121, which filters dust (e.g., material ground smaller than the desired output powder) from the air. The air is then drawn through 12″ pipe 123 by blower 102.

Materials separated by the separator fall into sieve 125, which sieves out the ground materials based on size. Ground materials that form the output powder exit through output chute 126 into collection bin 127. Oversize materials exit through chute 129 where they can be handled for recycling, disposal, or other handling.

Some dust can also exit the mill through the output chute along with the output powder, although most of the dust typically is captured by the filter house.

### SUMMARY OF THE INVENTION

One problem with existing mills is that a significant amount of output powder does not go into the collection bin. Instead, some of the powder bounces off of powder already in the bin or otherwise ends up in the air or outside of the bin. This powder typically is disposed of as waste, often via a complex and expensive vacuum system and/or other disposal system. Applicants realized that the amount of this wasted powder could be significant. In fact, depending on the nature and hardness of input materials and the rate at which the mill is run, as much as 2% to 6% (or even more) of the output powder can be lost in this way.

The invention attempts to reduce the amount of output powder that is disposed of as waste. The invention does this through the addition of a collector near the output chute of a mill and rearrangement of airflow through part of the mill to re-feed powder (and possibly some dust) collected by the collector back into the mill.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows a closed loop grinding mill that includes a collector by which output powder that might otherwise be wasted is re-fed to the mill.

FIGS. 2 and 3 show some details of one embodiment of the collector.

FIGS. 4 & 5 show some details of another embodiment of the collector.

FIG. 6 shows a prior art closed loop grinding mill without a collector according to the invention.

### DETAILED DESCRIPTION OF THE INVENTION

One problem with existing mills is that a significant amount of output powder does not go into the collection bin. Instead, some of the powder bounces off of powder already in the bin or otherwise ends up in the air or outside of the bin. This powder typically is disposed of as waste, often via a complex and expensive vacuum system and/or other disposal system. Applicants realized that the amount of this wasted powder could be significant. In fact, depending on the nature and hardness of input materials and the rate at which the mill is run, as much as 2% to 6% (or even more) of the output powder can be lost in this way.

Briefly, one aspect of the invention is a mill that includes a powder reclamation device that attempts to reclaim this powder. One embodiment of this device includes a collector positioned at an output chute of the mill and a connection for airflow from the collector back to the mill. Air and at least some powder that would have been wasted without the reclamation device is collected by the collector and re-fed to the mill through the connection. Other aspects of the invention include but are not limited to the reclamation device itself and a method of upgrading existing mills to include the reclamation device.

As will be apparent after reading this application, the invention can be implemented relatively simply. However, to Applicants' knowledge, nobody implemented the invention before Applicants. One possible reason is that people did not realize how much useable powder was being wasted. They might not have realized how much useable powder was being wasted for a couple of reasons. One possible reason is that modern waste disposal systems do a very good job of carrying away waste, so the wasted useable powder often is not even present to be observed. Another possible reason is that useable powder and dust can be difficult to tell apart visually with the naked eye, so people might not have realized that some or even most of the waste was useable powder. (Of course, the invention is not limited to cases where a disposal system is present or cases where useable powder and dust have a similar appearance.)

Details of various aspects and possible embodiments of the invention are described in more detail below.

### Basic Designs

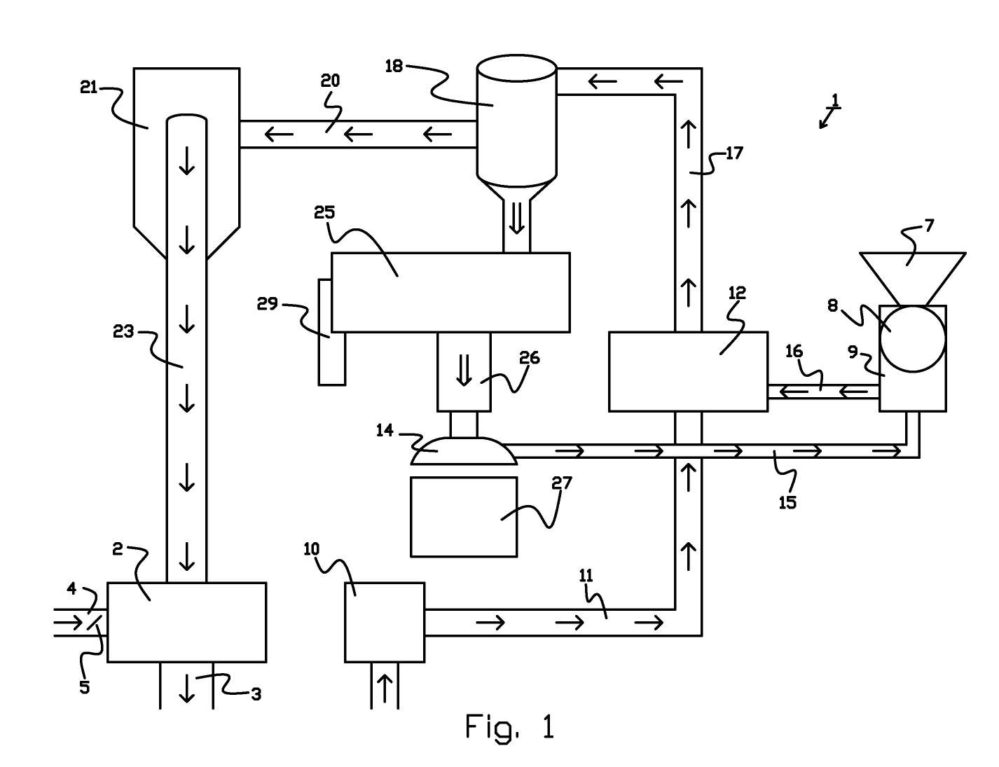

FIG. 1 shows a closed loop grinding mill that includes a collector by which at least some output powder that might otherwise be wasted is re-fed to the mill. Mill 1 in FIG. 1 is a “closed loop” grinding mill that can be used to grind input material into a powder that has a particular grain size or range of grain sizes. Blower 2 blows air out vent 3 to create suction that draws air through the mill. Inlet 4 and damper 5 are provided for controlling the amount of suction created by the blower. The mill is “closed” so the suction draws air through the mill. The flow of materials and air through the mill are described below. These flows are generally indicated by arrows in the figure.

Paint, metal, grain, plastic, and other materials to be ground by the mill are fed into hopper 7. The material can be in the form of chips, pellets, or any other suitable input form. The materials pass through rotor 8 in rotor housing 9. Rotor 8 helps to regulate flow of materials into the mill and also inhibits airflow from hopper 7. The materials then pass through rotor 8 in housing 9. Rotor 8 preferably helps to regulate flow of materials into the mill and also preferably inhibits airflow from hopper 7.

Air is drawn into the mill through chiller 10. The chilled air provides cooling for the mill. The air is drawn through 6″×10″ duct 11 to classifier 12. In a conventional mill, air would also be drawn from duct 11, through rotor housing 9 below rotor 8, and into classifier 12. However, according to the depicted embodiment of the invention, air is drawn from collector 14 through 4″ pipe 15, through rotor housing 9 (preferably) below rotor 8, through 4″ pipe 16, and into classifier 12. This airflow draws materials from rotor 8 into the classifier, which grinds the materials.

Air and ground materials are drawn from classifier 12 through 10″ pipe 17 to separator 18, which separates the ground materials from the air. Air is then drawn from the separator through 10″ pipe 20 to filter house 21, which filters dust (e.g., material ground smaller than the desired output powder) from the air. The air is then drawn through 12″ pipe 23 by blower 2.

Materials separated by the separator fall into sieve 25, which sieves out the ground materials based on size. Ground materials that form the output powder exit through output chute 26 into collection bin 27. Oversize materials exit through chute 29 where they can be handled for recycling, disposal, or other handling.

As mentioned above, air is drawn from collector 14 through 4″ pipe 15, past rotor 8, through 4″ pipe 16, and into classifier 12. Even with a conventional blower used in the mill, the collector should draw in significant airflow that should be powerful enough to draw in a significant amount of output powder that might otherwise be wasted. A significant amount of this powder can then flow from collector 14, through the mill, and back to output chute 26, where it has another chance to exit into collection bin 27.

Depending on the hardness and type of the materials being ground, a significant amount of the powder drawn in by collector 14 should end up going into the collection bin after one or more passes through the mill. As a result, yield improvements of between 2% and 6% can be expected depending on the hardness and type of materials being ground and the speed at which the mill is run. (Of course, the invention is not limited to embodiments that achieve these specific yield improvements.)

Collector 14 can also draws in some dust, which also gets re-fed through this mill. A significant amount of any dust drawn in by the collector should end up passing through separator 18 and going to filter house 21. Thus, waste disposal issues should be reduced.

In addition, because less output powder ends up having to be disposed of as waste using a separate waste disposal system, waste disposal issues should be further reduced. In fact, in some embodiments, the need for waste disposal can be almost completely eliminated by this aspect of the invention, although the invention is not limited to such embodiments.

In sum, the invention can result in at least the following three benefits:
(1) higher yields;
(2) less output powder being disposed of as waste, reducing waste disposal issues; and
(3) more dust captured by the filter housing, further reducing waste disposal issues.
   Not all embodiments of the invention will achieve all of these benefits, but many should.

In one test run that lasted about three months, similar hardness and types of materials were run through different mills. Some of the mills were arranged conventionally, and some were arranged according to the invention. The mills (e.g., blowers, chillers, classifiers, rotors, separators, sieves, etc.) were otherwise substantially identical. Total yield for the conventional mills was about 92.45%, while total yield for the mills arranged according to the invention was about 96.64%. Such a yield improvement clearly can have a significant impact on the bottom line of a mill operation.

It was determined that about 80% of the powder that would have been disposed of as waste instead went into the collection bin. Thus, in addition to improved yield, the embodiment of the invention used in the test resulted in significantly decreased costs for disposing of powder as waste.

Furthermore, the amount of dust captured by the filter house increased slightly, further reducing waste disposal issues.

Clearly, the overall economic impact of the invention can be very significant. For example, assume that a mill company runs 500,000 lbs. of material a month (a midsize mill) with a sales cost for the material of $2.50/lb. (not uncommon). Also assume that the invention results in a 4% average improvement in yield. That mill company would produce an extra 20,000 lbs. of material a month for substantially the same input costs. The net result is an extra $600,000 worth of powder produced per year, all at relatively no significant additional cost. Furthermore, costs of waste disposal should be significantly reduced.

Given that there are at least 250,000 mills operating in the world, the economic impact of the invention once applied to a significant number of the mills could easily run into the billions of dollars. This figure does not include additional savings that could be realized by using the invention instead of an expensive vacuum based waste disposal system or along with a less expensive (due to a less amount of waste to be handled) vacuum based waste disposal system.

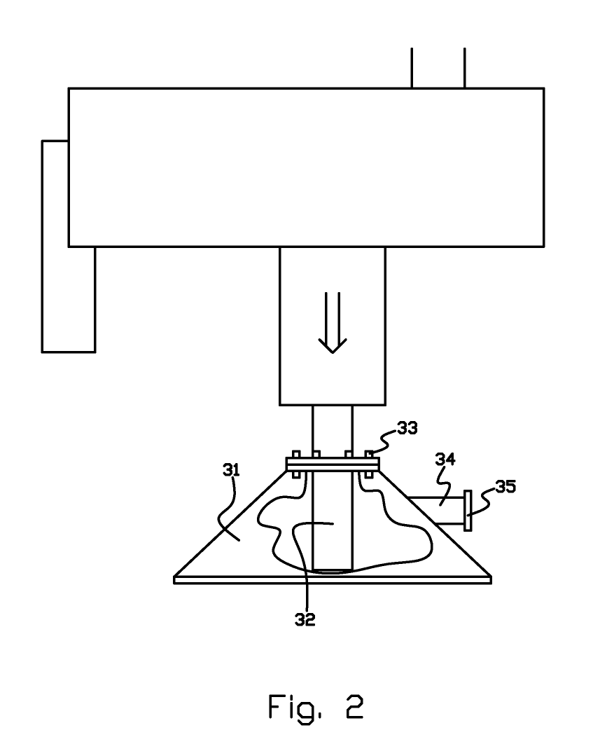

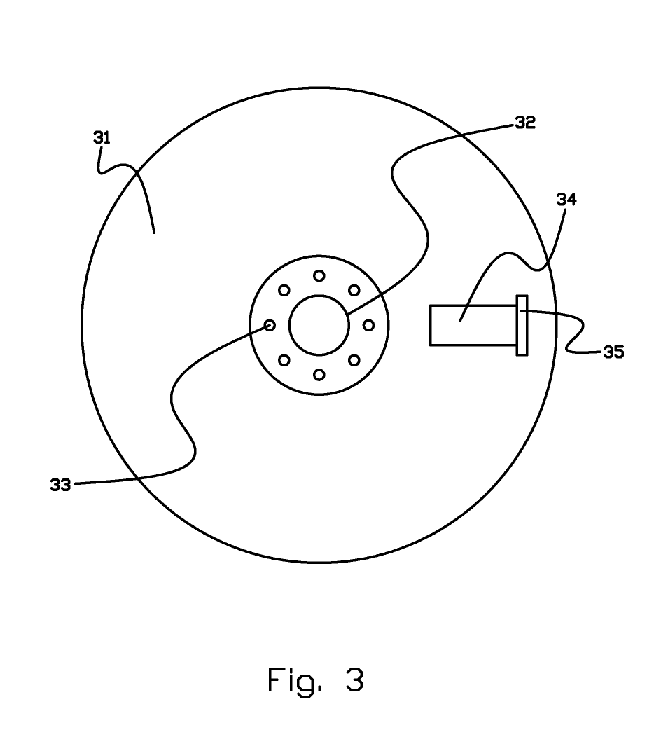

Collector 14 in FIG. 1 is shown as a having a bowl shape. In fact, the collector in the test was a metal salad bowl cut and affixed to the mill. Other shaped collectors can be used. FIGS. 2 and 3 show some details of another shaped embodiment. (Some of these details also could be applicable to the bowl shaped embodiment.)

Collector 31 in FIGS. 2 and 3 have a truncated cone shape. Shroud 32 (shown through cut-away in FIG. 2) preferably extends into the collector to (wholly or partially) inhibit powder properly directed toward the collection bin from being collected and re-fed through the mill. Bolts 33 are used to attach collector 31 to a mill. Any other form of attachment could be used. Pipe 34 with fitting 35 is provided for attachment to a pipe that leads back to the mill. Fitting 35 preferably is a quick connect fitting. Any other arrangement that permits airflow from the collector could be used. Collectors with different shapes, for example trapezoidal, rectangular, and the like, also could be used.

### Advanced Designs

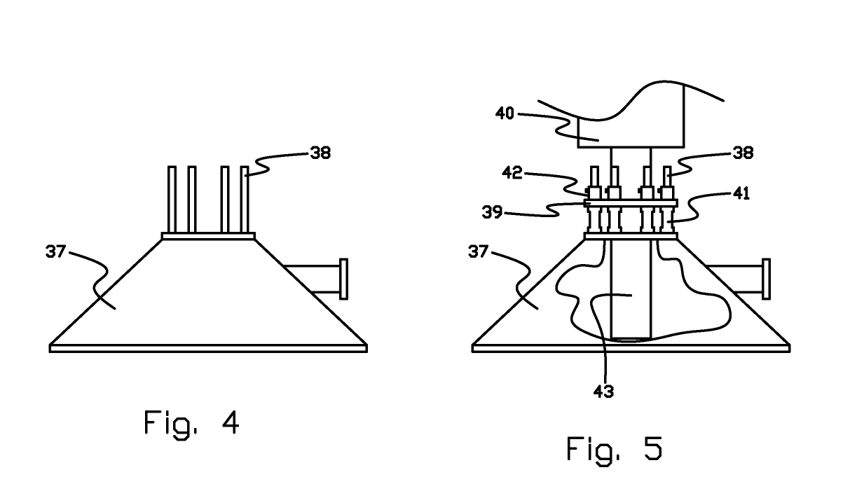

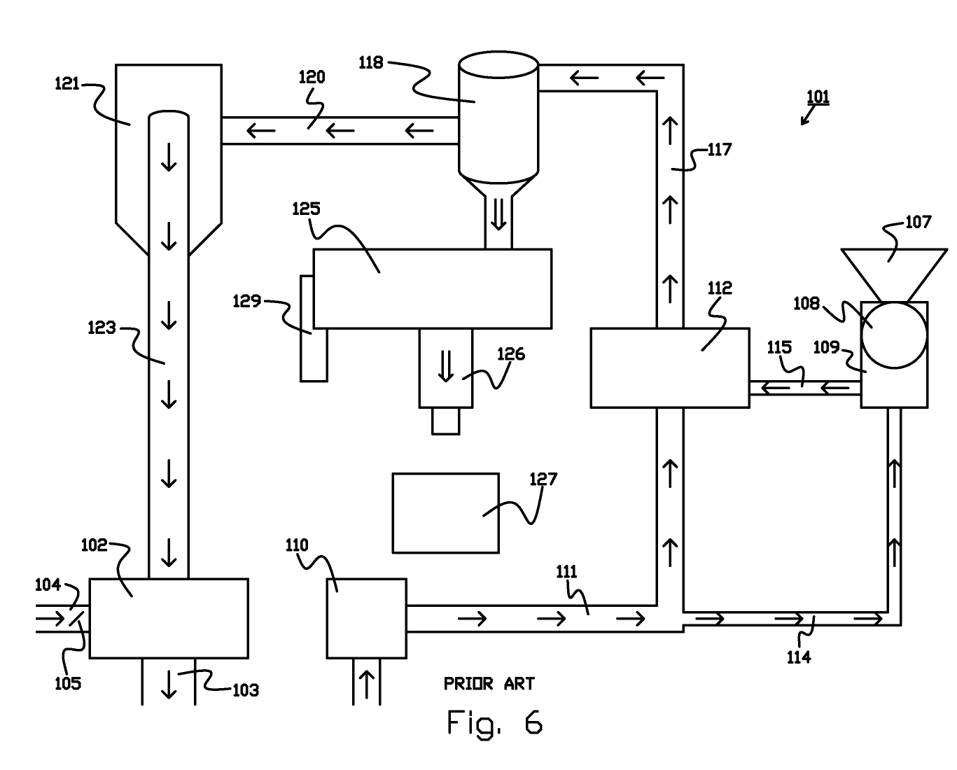

FIGS. 4 & 5 show some details of another embodiment of the collector. This embodiment includes dowel rods, spacers, and push button slide locks to permit quick and easy installation, removal, cleaning, and change-out of the collector and related components.

In more detail, collector 37 in FIGS. 4 & 5 includes dowel rods 38. When the collector is installed, these dowel rods pass through holes in plate 39 attached to a bottom of an exit chute for sieve 40 of the mill. Spacers 41 placed over dowel rods 38 preferably separate collector 37 from plate 39. Tube spacers akin to extended washers can be used. The dowel rods are locked into place by locks such as slide locks 42. Preferably, push button slide locks are used.

Collector 37 also preferably includes shroud 43 (shown through cut-away in FIG. 5). The shroud preferably extends to within an inch or so of the bottom of the collector. In some embodiments, the shroud is part of the collector. Alternatively, the shroud can be designed so that it can be changed out. One simple arrangement would be to provide a lip on the shroud that is larger than a hole cut into the top of the collector. Different shrouds could be simply dropped into place through this hole before the collector is installed. Other designs are possible.

The foregoing arrangements result in a stable and easily adjustable attachment of collector 37 to the mill. Furthermore, the arrangement permits quick and easy installation, removal, and cleaning of the collector and other components.

When a mill is changed over to process different hardnesses and/or compositions (e.g., resin content) of materials, is set to run at different speeds, or is used to fill different sized collection bins, different sized collectors and/or shrouds might better reclaim powder that would otherwise be wasted. The arrangement shown in FIGS. 4 and 5 also permits quick change out of collectors and/or shrouds according to such circumstances.

### Upgrading Mills

Upgrading an existing mill to use the invention should be a simple process. One embodiment of a method to do so includes the following steps:

(1) Attach a collector to the output chute for the mill; and

(2) Rearrange airflow through part of the mill to re-feed powder (and possibly some dust) collected by the collector back into the mill.

In a preferred embodiment, this second step can include the following steps:

(a) Disconnect the connection between the chiller and the rotor housing or other material feed structure; and

(b) Connect the collector to the rotor housing or other material feed structure so that collected powder (and possibly some dust) can flow from the collector to the rotor housing or other material feed structure.

Additional steps can also be included.

The foregoing method can be applied to other airflow based mills besides the one shown in FIG. 4. Furthermore, the invention is not limited to mills improved using these steps. For example, a mill could be originally manufactured to incorporate the invention.

### Mills Having Other Structures

The invention is not limited to the particular dimensions, ducts, and pipes described above with respect to the figures. For example, ducts could be replaced with pipes and vice versa, other sized ducts and/or pipes could be used, flex hoses could be used in place of some of the ducts and/or pipes, etc. The invention also is not limited to the specific mill depicted in the figures. For example, some grinding mills have one or more additional classifiers, output chutes, and possibly other components, while other mills use different components instead of some of the depicted components. The invention is applicable to these mills as well. In fact, the powder reclamation device of the invention can be used with any type of mill to which a collector can be added and airflow (e.g., suction) back to the mill can be provided.

### Alternative Embodiments

The invention is in no way limited to the specifics of any particular embodiments and examples disclosed herein. For example, the terms “preferably,” “preferred,” “can,” “can be,” “should,” “one embodiment,” “preferred embodiment,” “for example,” “alternatively,” and the like denote features that are preferable but not essential to include in embodiments of the invention. Many other variations are possible which remain within the content, scope and spirit of the invention, and these variations would become clear to those skilled in the art after perusal of this application.

What is claimed is:

1. A reclamation device for a mill comprising:
a collector positioned at an output chute of the mill; and
a connection for airflow from the collector back to the mill;
wherein air and at least some powder that would have been wasted without the reclamation device is collected by the collector and re-fed to the mill through the connection.

2. A reclamation device as in claim 1, wherein the collector includes a shroud that extends into the collector.

3. A reclamation device as in claim 1, wherein the connection comprises a pipe, duct, or flex-hose.

4. A reclamation device as in claim 1, further comprising dowel rods attached to the collector, spacers, and slide locks that permit a stable and easily adjustable attachment of the collector to the mill.

5. A closed loop grinding mill with a reclamation device, comprising:
a blower that draws air through the mill;
a hopper through which materials are fed to the mill;
a rotor in a rotor housing into which the materials pass from the hopper;
a chiller that chills air drawn into the mill;
a classifier through which air from the chiller and air and materials from the rotor housing are drawn;
a separator through which air and materials from the classifier are drawn;
a filter house through which air from the separator is drawn by the blower;
a sieve into which materials separated by the separator fall;
an output from the sieve through which output powder exits; and
a reclamation device including a collector positioned at the output of the mill and a connection for airflow from the collector back to the rotor housing, wherein air and at least some powder that would have been wasted without the reclamation device is collected by the collector and re-fed to the rotor housing through the connection.

6. A closed loop grinding mill as in claim 5, wherein the collector includes a shroud that extends into the collector.

7. A closed loop grinding mill as in claim 5, wherein the connection included in the reclamation device comprises a pipe, duct, or flex-hose.

8. A closed loop grinding mill as in claim 5, wherein the reclamation device further comprises dowel rods attached to the collector, spacers, and slide locks that permit a stable and easily adjustable attachment of the collector to the mill.

9. A method of upgrading a mill to include a reclamation device, comprising the steps of:
attaching a collector to the output chute for the mill; and
rearranging airflow through part of the mill to re-feed powder collected by the collector back into the mill.

10. A method as in claim 9, wherein the step of rearranging the airflow further comprises the steps of:
disconnecting a connection between a chiller in the mill and a material feed structure in the mill; and
connecting the collector to the material feed structure so that collected powder can flow from the collector to the material feed structure.

11. A method as in claim 9, wherein the collector includes a shroud that extends into the collector.

12. A method as in claim 9, wherein the collector is attached to the mill using dowel rods attached to the collector, spacers, and slide locks.
